(19) United States
(12) Patent Application Publication
(10) Pub. No.: US 2018/0137489 A1
(43) Pub. Date: May 17, 2018

(54) METHOD FOR OPERATING A BEACON-BASED VENDING SYSTEM

(71) Applicant: EVER GRAND INTERNATIONAL CO., LTD., Taipei City (TW)

(72) Inventors: Kuan-Chun CHANG, Taipei City (TW); Hsin-Ke LU, Taipei City (TW)

(21) Appl. No.: 15/352,637

(22) Filed: Nov. 16, 2016

(51) Int. Cl. G06Q 20/18; G06Q 20/20; G06Q 20/32; G06Q 20/36; G07F 11/00

(52) U.S. Cl. CPC G06Q 20/18; G06Q 20/202; H04W 8/005; G06Q 20/36; G07F 11/002; G06Q 20/3224

(57) ABSTRACT

A method for operating a beacon-based vending system with a vending machine and multiple mobile devices includes steps of selecting a merchandise item through the vending machine, performing a beacon payment selection through the vending machine, determining if one of the mobile devices is a payer device according to the beacon payment selection result through a first beacon transceiving module of the vending machine, when the mobile device is a payer device, unlocking a beacon payment function of the beacon application installed on the payer device through the first beacon transceiving module, and performing the beacon payment function of the beacon application through the payer device. Given the method, a secure, precise and simplified transaction process can be achieved, users' operational convenience can be enhanced, and transaction time can be shortened.

### BACKGROUND OF THE INVENTION

### 1. Field of the Invention

The present invention relates to a method for operating a vending machine and, more particularly, to a method for operating a beacon-based vending system.

### 2. Description of the Related Art

Conventional vending machines mostly utilize their internal space for storing and showcasing merchandise and provide a man-machine interface for customers to select items to be purchased and get the selected items after paying for the item with currency or credit.

In view of rapid technological development and widespread wireless networks, conventional vending machines are gradually facing the fate to be phased out. Instead, more and more new humanized and interactive vending machines are in the market. In contrast to the conventional vending machines, those new vending machines not only provide a variety of merchandise items, touch user interface, and diversified payment means, such as stored-value IC card, debit card, QR code, or the like, and are further collaborated with techniques of wireless networks and mobile devices to provide more convenient and. user-friendly vending services. For example, vending machine consumers can remotely operate new types of vending machines by means of WiFi (Wireless Fidelity), Bluetooth, text message and the like through consumers' smart phones in completion of purchase of available merchandise.

However, when consumers interact with the new types of vending machines to purchase merchandise by means of wireless communication, such as WiFi, Bluetooth, text message and the like, security authentication is required throughout the process of transaction. In other words, regardless of wireless connection through WiFi, Bluetooth or text message, consumers are all required to provide personal identity for security authentication, such as password entered through consumers' mobile devices or encryption key used by consumers' mobile devices in communication with the new types of vending machines. No matter what type of identify for security authentication, vending services are available only after the vending machines correctly authenticate cons identity. Such necessity, which not only causes inconvenience to consumers upon operation but also takes more consumers' time in transaction, certainly impacts consumers' purchase intention.

### SUMMARY OF THE INVENTION

An objective of the present invention is to provide a method for operating a beacon-based vending system allowing users to perform security authentication. of identity, enhance operational inconvenience, shortening transaction time, and motivate consumers' buying intention with a wireless communication means in communication with a vending machine during purchase of merchandise.

To achieve the foregoing objective, the method for operating a beacon-based vending system, in which the vending system has a vending machine and multiple mobile devices, the vending machine has a first beacon transceiving module and a control module electrically connected, and each mobile device is installed with a beacon application, includes steps of:

selecting a merchandise item according to a user's operation on the vending machine for the vending machine to generate a merchandise selection result;

performing a beacon payment selection according to the user's operation and the merchandise selection result to generate a beacon payment selection result through the vending machine;

determining if one of the mobile devices is a payer device according to the beacon payment selection result through the first beacon transceiving module of the vending machine;

when the mobile device is a payer device, unlocking a beacon payment function of the beacon application installed on the payer device through the first beacon transceiving module; and

performing the beacon payment function of the beacon application through the payer device.

To achieve the foregoing objective, the method for operating a beacon-based vending system, in which the vending system has a vending machine and multiple mobile devices, the vending machine has a first beacon transceiving module and a control module electrically connected, and each mobile device is installed with a beacon application, includes steps of:

selecting a merchandise item according to a user's operation on one of the mobile devices for the mobile device to generate a merchandise selection result;

determining if the mobile devices is a payer device according to the merchandise selection result through the first beacon transceiving module of the vending machine;

when the mobile device is the payer device, unlocking the beacon payment function of the beacon application installed on the payer device through the first beacon transceiving module; and

performing the beacon payment function of the beacon application through the payer device.

Given the foregoing method for operating a beacon-based vending system, no additional security authentication is required to authenticate user's identity, thereby attaining secure and precise transaction, simplifying consumers' transaction processes, shortening transaction time, enhancing users' operational convenience, and increasing consumer s purchasing intention.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view showing system architecture of a beacon-based vending system in accordance with the present invention;

FIG. 2 is a functional block diagram showing the beacon-based vending system and a mobile device in FIG. 1 interacting with each other;

FIG. 3 is an operational schematic view of the beacon-based vending system in FIG. 1;

FIG. 4 is a sequence diagram showing a first type of operation of the beacon-based vending system in FIG. 1;

FIG. 5 is a sequence diagram showing a second type of operation of the beacon-based vending system in FIG. 1;

FIG. 6 is a sequence diagram showing a third type of operation of the beacon-based vending system in FIG. 1;

FIG. 7 is a sequence diagram showing a fourth type of operation of the beacon-based vending system in FIG. 1;

FIG. 8 is a flow diagram of a first embodiment of a method for operating the beacon-based vending system according to the first type of operation in FIG. 4;

FIG. 9 is a flow diagram of a second embodiment of a method for operating the beacon-based vending system according to the second type of operation in FIG. 5;

FIG. 10 is a flow diagram of a third embodiment of a method for operating the beacon-based vending system according to the third type of operation in FIG. 6; and

FIG. 11 is a flow diagram of a fourth embodiment of a method for operating the beacon-based vending system according to the fourth type of operation in FIG. 4.

### DETAILED DESCRIPTION OF THE INVENTION

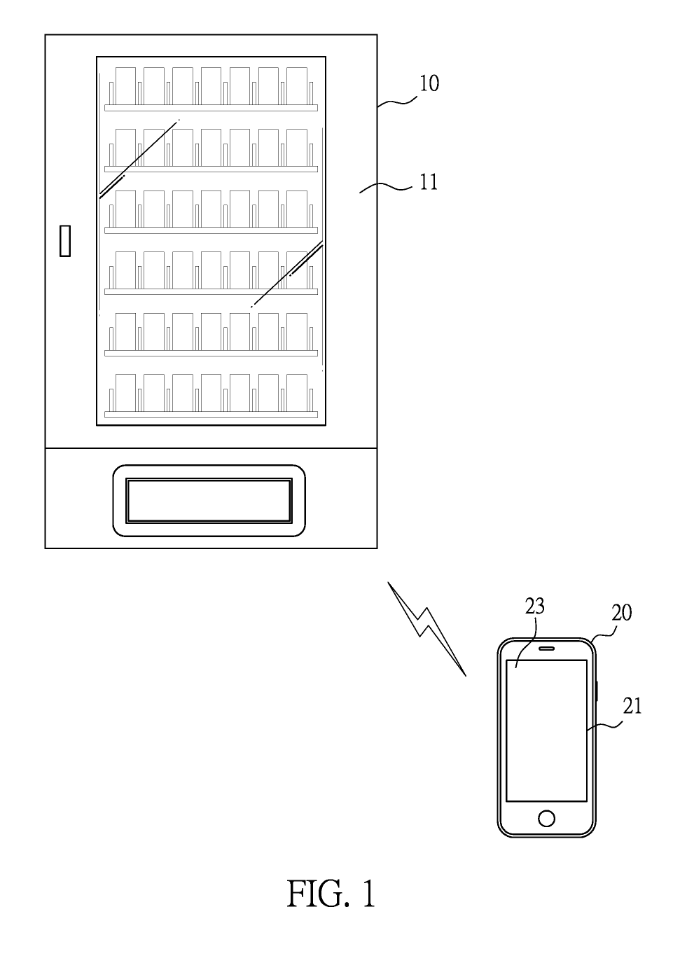

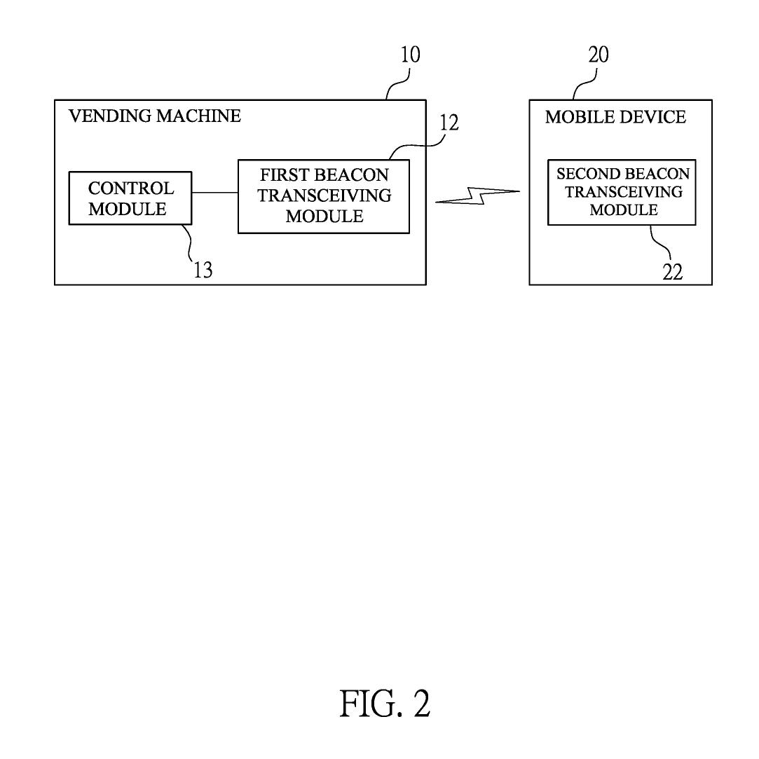

With reference to FIGS. 1 and 2, a beacon-based vending system in accordance with the present invention includes a vending machine 10 and at least one mobile device 20. The vending machine 10 has an operation interface 11, a first beacon transceiving module 12 and a control module 13. The operation interface 11 is mounted on a housing of the vending machine 10 to provide a man-machine interface for users to operate the vending machine 10. The first beacon transceiving module 12 and the control module 13 are mounted inside the vending machine 10 and are electrically connected. The first beacon transceiving module 12 may be a full-duplex beacon-based device, which is capable of transmitting and receiving beacon signals. The control module 13 serves to control the vending machine 10.

The at least one mobile device 20 may include one of a smart phone, a tablet computer, a notebook computer and the like. Each one of the at least one mobile device 20 includes a display screen 21, a second beacon transceiving module 22 and a beacon application (hereinafter APP). The second beacon transceiving module 22 is mounted inside the mobile device 20 and may be a full-duplex beacon-based device, which is capable of transmitting and receiving beacon signals. When the mobile device 20 executes the beacon APP, a user interface 23 is shown on the display screen 21 as an interface for users to operate the beacon APP. The beacon APP is an application in association with beacon-related operation in the vending machine 10. The second beacon transceiving module 22 of the mobile device 20 communicates with the first beacon transceiving module 12 of the vending machine 10 to perform interactive operation between the vending machine 10 and the at least one mobile device 20.

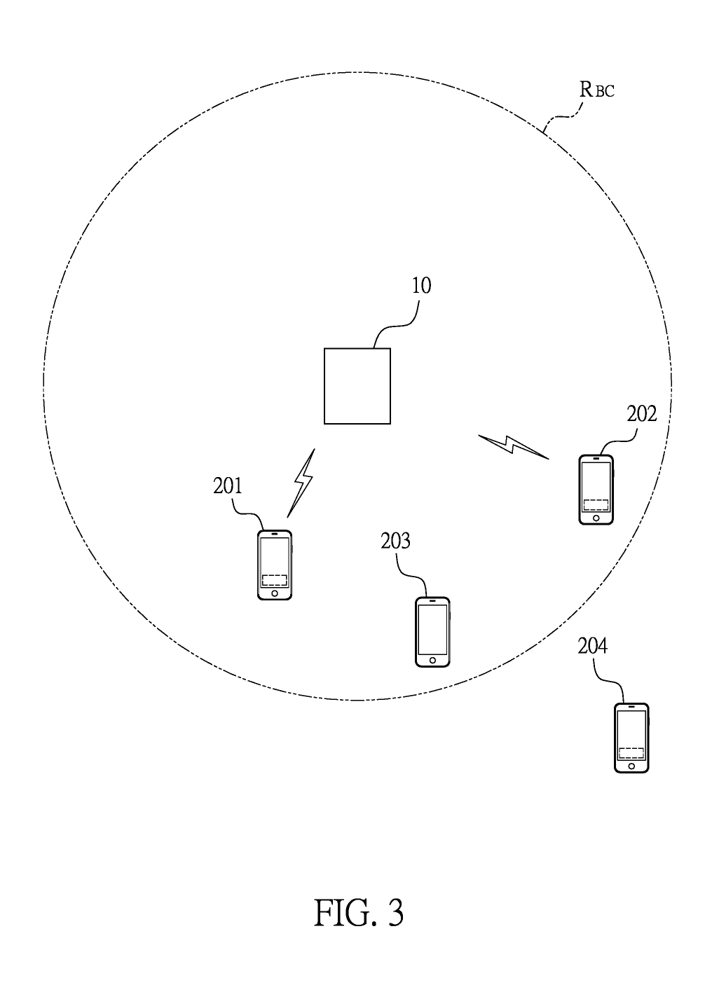

With reference to FIG. 3, an effective zone R_{BC} of the first beacon transceiving module 12 of the vending machine 10 represents a coverage area within which the first beacon transceiving module 12 can perform a scanning function and a transmitting function. In other words, the first beacon transceiving module 12 of the vending machine 10 is capable of scanning any mobile device with the beacon APP installed and executed thereon within the effective zone R_{BC}. Beacon signals transmitted from the first beacon transceiving module 12 can he read by the mobile device with the beacon APP installed and executed thereon within the effective zone R_{BC}. The effective zone R_{BC} centered by the vending machine 10 is considered as an area with a diameter allowing communication of signals with effective intensity therein. The diameter of the effective zone R_{BC} of the first beacon transceiving module 12 is selected based on actual demands and may include but is not limited to one meter. As an example, a first mobile device 201, a second mobile device 202 and a fourth mobile device 204 are all installed with the beacon APP while a third mobile device 203 has no beacon APP installed thereon. Although users are in possession of those mobile devices, only mobile devices are mentioned to simplify the following description. As can be seen from FIG. 3, multiple operation situations occur between the vending machine 10 and the mobile devices 20. Technical features of the present invention are not restricted to the quantity, scale and locations of the mobile devices 20 shown in FIG. 3.

Speaking of the scanning function of the first beacon transceiving module 12 of the vending machine 10, the first beacon transceiving module 12 can scan and detect the first mobile device 201 and the second mobile device 202 with the beacon APP installed and executed thereon within the effective zone R_{BC}. Besides, as the third mobile device 203 is not installed with the beacon APP. the first beacon transceiving module 12 fails to detect the third mobile device 203 even if the third mobile device 203 is in the effective zone R_{BC}. Also because the fourth mobile device 204 is outside the effective zone R_{BC}, the first beacon transceiving module 12 fails to detect the fourth mobile device 204 even if the fourth mobile device 204 is installed with the beacon APP.

Speaking of the transmitting function of the first beacon transceiving module 12, beacon signals transmitted from the first beacon transceiving module 12 can be read by the first mobile device 201 and the second mobile device 202 with the beacon APP installed and executed thereon. Besides, as the third mobile device 203 is not installed with the beacon APP, the third mobile device 203 fails to read the beacon signals transmitted from the first beacon transceiving module 12. Also because the fourth mobile device 204 is outside the effective zone R_{BC}, the fourth mobile device 204 fails to detect the beacon signals transmitted from the first beacon transceiving module 12 even if the fourth mobile device 204 is installed with the beacon APP.

Classified according to different applications, the beacon-based vending system has four types of operation situations as follows.

Operation situation I:

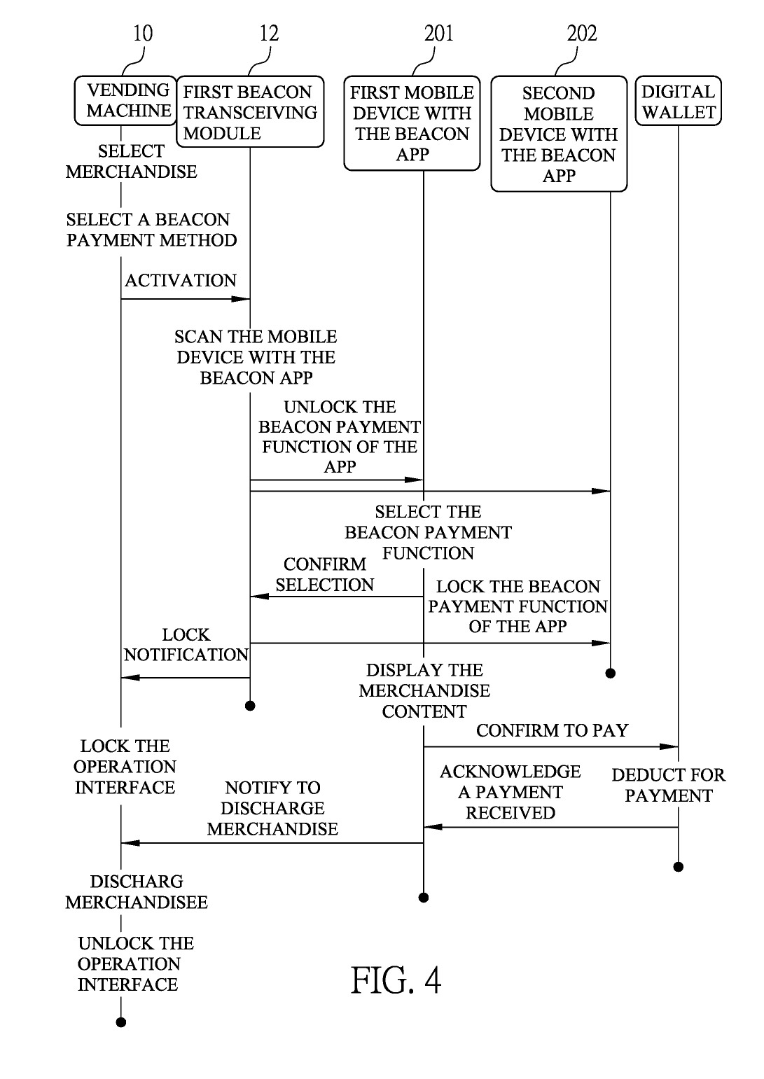

The first beacon transceiving module 12 provides the scanning function for users to perform purchase operation on the vending machine 10. With reference to FIGS. 3 and 4, suppose that the user in possession of the first mobile device 201 (hereinafter user A) performs purchase operation on the vending machine 10 and the user A and the user in possession of the second mobile device 202 (hereinafter user B) are both located within the effective zone R_{BC}. First of all, the user A selects a merchandise item to be purchased on the operation interface II of the vending machine 10. The vending machine 10 performs a merchandise selection to generate a merchandise selection result including the merchandise item and a price thereof selected by the user A.

Usually, payment methods available to vending machines include cash, IC card with stored value, debit card or QR (Quick Response) code. In the present invention, the beacon-based vending system not only provides the foregoing payment methods but also a beacon payment method. The user A further selects a beacon payment method for a current transaction, the vending machine 10 perform a beacon payment selection according to operation of the user A and the merchandise selection result to generate a beacon payment selection result, which is the beacon payment method selected by the user A. When receiving the selected beacon payment method, the control module 13 of the vending machine 10 activates the first beacon transceiving module 12. Thus, before confirmation of the selected beacon payment method, the first beacon transceiving module 12 stays at an idle or standby state and is not activated until the confirmation of the selected beacon payment method. Accordingly, the first beacon transceiving module 12 has economical power consumption and prolonged life duration.

After the first beacon transceiving module 12 is activated, the first beacon transceiving module 12 starts scanning the mobile devices with the beacon APP installed and executed thereon within the effective zone R. In the present situation, the first beacon transceiving module 12 detects the first mobile device 201 and the second mobile device 202. As mentioned earlier, the first mobile device 201 is owned by the user A who is the consumer purchasing merchandise at the moment.

After detecting the first mobile device 201 and the second mobile device 202, the first beacon transceiving module 12 unlocks a beacon payment function of the beacon APPs installed on the first mobile device 201 and the second mobile device 202. After being aware of the notice that the beacon payment function of the beacon. APP installed on the first mobile device 201 is unlocked, the user A chooses the beacon payment function on the user interface 23. After the beacon payment function is chosen, the second beacon transceiving module 22 of the first mobile device 201 transmits a signal or message for confirming selection of the beacon payment function to the first beacon transceiving module 12. The signal or message for confirming selection of the beacon payment function transmitted by each mobile device has its dedicated identity authentication data with a device ID or device identification data contained therein. After receiving the signal or message for confirming selection of the beacon payment function, the first beacon transceiving module 12 authenticates that the owner of the first mobile device 201, the user A, is the payer of the instant transaction. In other words, the first mobile device 201 is a payer device. Hence, the first beacon transceiving module 12 locks the beacon payment function of the beacon APP(s) installed on other mobile device(s) excluding the first mobile device 201. In the present situation, the beacon payment function of the beacon APP installed on the second mobile device 202 is locked as the second mobile device 202 is not a payer for the instant transaction, such that the user B is prevented from simultaneously choosing the beacon payment function and a situation that two payers are paying for a single transaction can be avoided.

After the beacon payment function of the beacon APP(s) of the other mobile device(s) is locked, the first beacon transceiving module 12 transmits a signal or message for locking the operation interface 11 of the vending machine 10 to the control module 13 for the control module 13 to lock the operation interface 11 and display a message prompt on the operation interface for informing that a pending transaction is not finished yet, thereby preventing other users from performing purchase operation on the vending machine 10 before a pending transaction is completed.

After the user A chooses the beacon payment function on the user interface 23 of the first mobile device 201, purchasing content, such as merchandise name, quantity, amount and the like, of the instant transaction is displayed on the user interface 23. The user A can then select options on the user interface 23 for confirming payment or cancelling the transaction in handling the instant transaction. After the option for payment confirmation is selected, the beacon APP of the first mobile device 201 adopts a beacon payment method through a payment service using digital wallet (eDollar). After the digital wallet is deducted for payment, the beacon APP of the first mobile device 201 informs the user A. The first beacon transceiving module 12 then transmits a signal or message for discharging merchandise to the control module 13 for the control module 13 to control the vending machine 10 to discharge the merchandise. After the merchandise is discharged, the control module 13 unlocks the operation interface 11 of the vending machine 10, allowing other user(s) to perform purchase operation on the vending machine 10.

Operation situation II:

The first beacon transceiving module 12 provides the scanning function and users perform purchase operation on the mobile devices. With reference to FIGS. 3 and. 5, the operation situation II differs from the foregoing operation situation I as shown in FIG. 4 in that the user A performs purchase operation on the user interface 23 of the first mobile device 201. Under the operation situation II, the vending machine 10 stays at a standby state indicating that there is no user operating the vending machine 10 through the operation interface 11 of the vending machine 10. Supposing that there is any other user performing purchase operation on the vending machine 10, those transactions are handled on a prioritized basis. Meanwhile, under the operation situation II, the first beacon transceiving module 12 stays at an idle state or a standby state. The control module activates the first beacon transceiving module 12 until there is no user operating the vending machine 10. Accordingly, the first beacon transceiving module 12 has economical power consumption and prolonged life duration.

When there is no user operating the vending machine 10, the user A selects merchandise to be purchased on the user interface 23. The first mobile device 201 performs a merchandise selection according to operation of the user A to generate a merchandise selection result including merchandise item and price selected by the user A. As directly conducting a transaction directly through the beacon APP, the user A does not have to select the beacon payment method and the beacon payment method is automatically set to be default.

After being activated, the first beacon transceiving module 12 scans the effective zone R_{BC} to detect the first mobile device 201 and the second mobile device 202 with the beacon APP installed and executed thereon. The owner of the first mobile device 201 is the consumer who performs the instant transaction.

After detecting the first mobile device 201 and the second mobile device 202, the first beacon transceiving module 12 unlocks the beacon payment function of the beacon APP of each of the first mobile device 201 and the second mobile device 202. After being aware of the notice that the beacon payment function of the beacon. APP installed on the first mobile device 201 is unlocked, the user A chooses the beacon payment function on the user interface 23. After the beacon payment function is chosen, the second beacon transceiving module 22 of the first mobile device 201 transmits a signal or message for confirming selection of the beacon payment function to the first beacon transceiving module 12. After receiving the signal or message for confirming selection of the beacon payment function, the first beacon transceiving module 12 authenticates that the owner of the first mobile device 201, the user A, is the payer of the instant transaction. In other words, the first mobile device 201 is a payer device. Hence, the first beacon transceiving module 12 locks the beacon payment function of the beacon APP(s) installed on other mobile device(s) excluding the first mobile device 201. In the operation situation II, the beacon payment function of the beacon APP installed on the second mobile device 202 is locked as the second mobile device 202 is not a payer for the instant transaction, such that the user B is prevented from simultaneously choosing the beacon payment function and a situation that two payers are paying for a single transaction can be avoided.

After the beacon payment function of the beacon APP(s) of the other mobile device(s) is locked, the first beacon transceiving module 12 transmits a signal or message for locking the operation interface 11 of the vending machine 10 to the control module 13 for the control module 13 to lock the operation interface 11 and display a message prompt on the operation interface for informing that a pending transaction is not finished yet, thereby preventing other users from performing purchase operation on the vending machine 10 before a pending transaction is completed.

After the user A chooses the beacon payment function on the user interface 23 of the first mobile device 201, purchasing content, such as merchandise name, quantity, amount and the like, of the instant transaction is displayed on the user interface 23. The user A can then select options on the user interface 23 for confirming payment or cancelling the transaction in handling the instant transaction. After the option for payment confirmation is selected, the beacon APP of the first mobile device 201 adopts a beacon payment method through a payment service using digital. wallet. After the digital wallet is deducted for payment, the beacon APP of the first mobile device 201 informs the user A. The first beacon transceiving module 12 then transmits a signal or message for discharging merchandise to the control module 13 for the control module 13 to control the vending machine 10 to discharge the merchandise. After the merchandise is discharged, the control module 13 unlocks the operation interface 11 of the vending machine 10, allowing other user(s) to perform purchase operation on the vending machine 10.

Operation situation III:

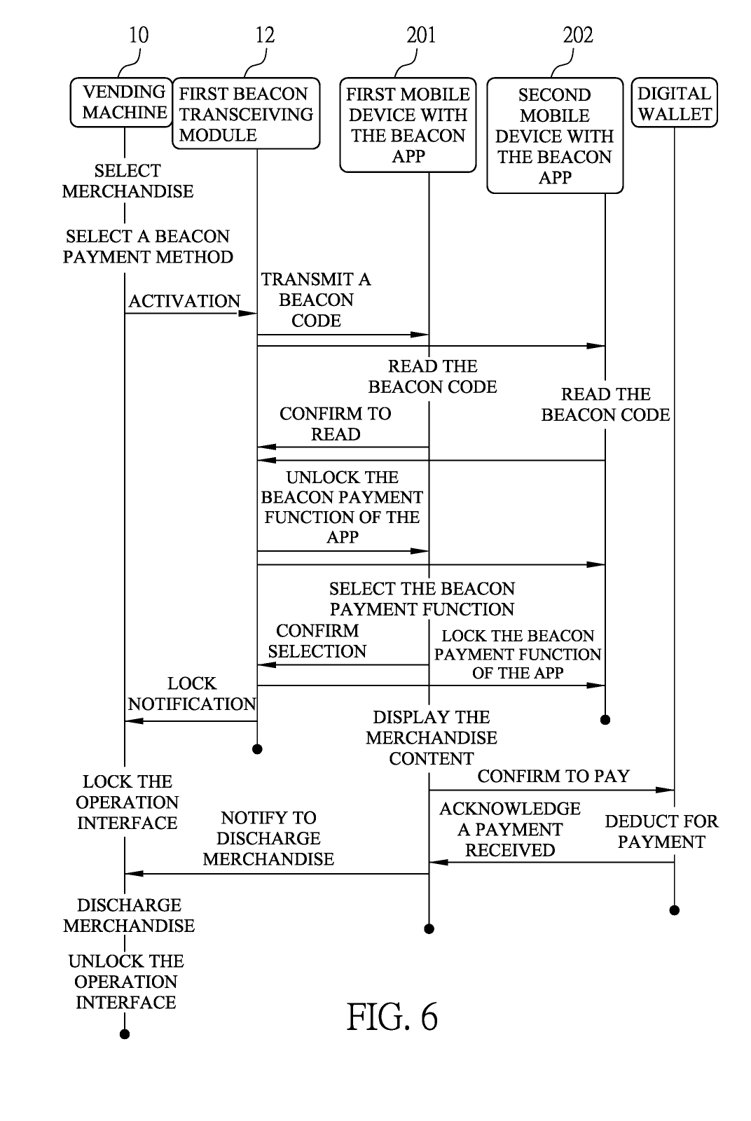

The first beacon transceiving module 12 provides the transmitting function and users perform purchase operation on the vending machine 10. With reference to FIGS. 3 and 6, the operation situation III differs from the operation situation I as shown in FIG. 4 in that the vending machine 10 actively transmits beacon signals to provide a beacon code of the vending machine 10.

The user A first selects merchandise to be purchased on the operation interface 11 of the vending machine 10. The vending machine 10 performs a merchandise selection to generate a merchandise selection result including the merchandise item and a price thereof selected by the user A.

The user A further selects a payment method of the instant transaction. The vending machine 10 performs a beacon payment selection according to the merchandise selection result and operation of the user A to generate a beacon payment selection result including a beacon payment method selected by the user A. When receiving the selected beacon payment method, the control module 13 of the vending machine 10 activates the first beacon transceiving module 12.

After being activated, the first beacon transceiving module 12 actively transmits beacon signals including a beacon code of the first beacon transceiving module 12. The first mobile device 201 and the second mobile device 202 within the effective zone R_{BC} can read the beacon code provided by the first beacon transceiving module 12. The second beacon transceiving modules 22 of the first mobile device 201 and the second mobile device 202 transmit signals or messages for read acknowledgement of the beacon code to the first beacon transceiving module 12. The signals or messages for read acknowledgement of the beacon code transmitted from the first mobile device 201 and the second mobile device 202 have their dedicated identity authentication data with a device ID or device identification data contained therein.

After receiving the signals or message for read acknowledgement of the beacon code, the first beacon transceiving module 12 unlocks the beacon payment functions of the beacon APPS installed on the first mobile device 201. and the second mobile device 202. After being aware of the notice that the beacon payment function of the beacon APP installed on the first mobile device 201 is unlocked, the user A chooses the beacon payment function on the user interface 23. After the beacon payment function is chosen, the second beacon transceiving module 22 of the first mobile device 201 transmits a signal or message for confirming selection of the beacon payment function to the first beacon transceiving module 12. After receiving the signal or message for confirming selection of the beacon payment function, the first beacon transceiving module 12 authenticates that the owner of the first mobile device 201, the user A, is the payer of the instant transaction. In other words, the first mobile device 201 is a payer device. Hence, the first beacon transceiving module 12 locks the beacon payment function of the beacon APP(s) installed on other mobile device(s) excluding the first mobile device 201. In the present situation, the beacon payment function of the beacon APP installed on the second mobile device 202 is locked as the second mobile device 202 is not a payer for the instant transaction, such that the user B is prevented from simultaneously choosing the beacon payment function and a situation that two payers are paying for a single transaction can be avoided.

After the beacon payment function of the beacon APP(s) of the other mobile device(s) is locked, the first beacon transceiving module 12 transmits a signal or message for locking the operation interface 11 of the vending machine 10 to the control module 13 for the control module 13 to lock the operation interface 11 arid display a message prompt on the operation interface for informing that a pending transaction is not finished yet, thereby preventing other users from performing purchase operation on the vending machine 10 before a pending transaction is completed.

After the user A chooses the beacon payment function on the user interface 23 of the first mobile device 201, purchasing content, such as merchandise name, quantity, amount and the like, of the instant transaction is displayed on the user interface 23. The user A can then select options on the user interface 23 for confirming payment or cancelling the transaction in handling the instant transaction. After the option for payment confirmation is selected, the beacon APP of the first mobile device 201 adopts a beacon payment method through a payment service using digital. wallet. After the digital wallet is deducted for payment, the beacon APP of the first mobile device 201 informs the user A. The first beacon transceiving module 12 then transmits a signal or message for discharging merchandise to the control module 13 for the control module 13 to control the vending machine 10 to discharge the merchandise. After the merchandise is discharged, the control module 13 unlocks the operation interface 11 of the vending machine 10, allowing other user(s) to perform purchase operation on the vending machine 10.

Operation situation IV:

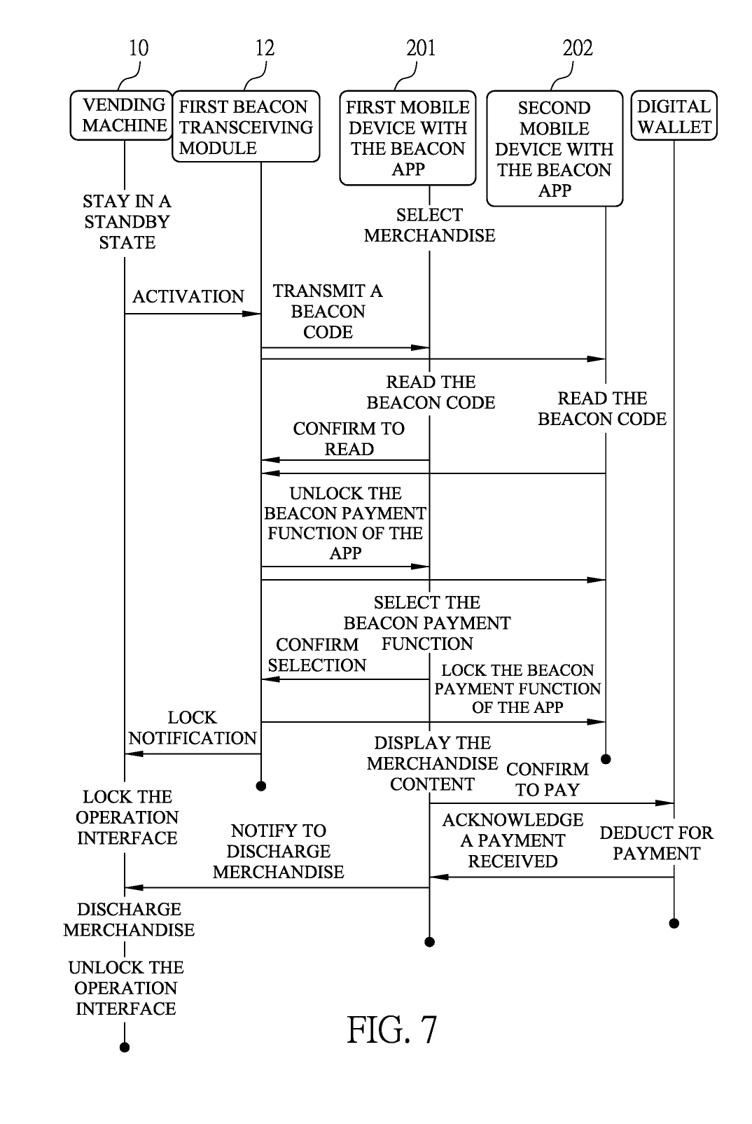

The first beacon transceiving module 12 provides the transmitting function and users perform purchase operation on the mobile devices 20. With reference to FIGS. 3 and 7, the operation situation IV differs from the operation situation III as shown in FIG. 6 in that the user A performs purchase operation on the user interface 23 of the first mobile device 201. Under the operation situation IV, the vending machine 10 stays at a state without user operating the vending machine 10 and the control module 13 activates the first beacon transceiving module 12. Under the state that no user operates the vending machine 10 through the operation interface 11 of the vending machine 10, the user A selects a merchandise item to be purchased on the user interface 23. The first mobile device 201 performs a merchandise selection according to operation of the user A to generate a merchandise selection result including the merchandise item and a price thereof selected by the user A. As the user A performs transaction directly through the beacon APP, the user A does not have to select the beacon payment method and the beacon payment method is automatically set to be default.

After being activated, the first beacon transceiving module 12 actively transmits beacon signals including a beacon code of the first beacon transceiving module 12. The first mobile device 201 and the second mobile device 202 within the effective zone R_{BC} can read the beacon code provided by the first beacon. transceiving module. The second beacon transceiving modules 22 of the first mobile device 201 and the second mobile device 202 transmit signals or messages for read acknowledgement of the beacon code to the first beacon transceiving module 12.

After receiving the signals or message for read acknowledgement of the beacon code, the first beacon transceiving module 12 unlocks the beacon payment functions of the beacon APPs installed on the first mobile device 201 and the second mobile device 202. After being aware of the notice that the beacon payment function of the beacon APP installed on the first mobile device 201 is unlocked, the user A chooses the beacon payment function on the user interface 23. After the beacon payment function is chosen, the second beacon transceiving module 22 of the first mobile device 201 transmits a signal or message for confirming selection of the beacon payment function to the first beacon transceiving module 12. After receiving the signal or message for confirming selection of the beacon payment function, the first beacon transceiving module 12 authenticates that the owner of the first mobile device 201, the user A, is the payer of the instant transaction. in other words, the first mobile device 201 is a payer device. Hence, the first beacon transceiving module 12 locks the beacon payment function of the beacon APP(s) installed on other mobile device(s excluding the first mobile device 201. In the present situation, the beacon payment function of the beacon APP installed on the second mobile device 202 is locked as the second mobile device 202 is not a payer for the instant transaction, such that the user B is prevented from simultaneously choosing the beacon payment function and a situation that two payers are paying for a single transaction can be avoided.

After the beacon payment function of the beacon APP(s) of the other mobile device(s) is locked, the first beacon transceiving module 12 transmits a signal or message for locking the operation interface 11 of the vending machine 10 to the control module 13 for the control module 13 to lock the operation interface 11 and display a message prompt on the operation interface for informing that a pending transaction is not finished yet, thereby preventing other users from performing purchase operation on the vending machine 10 before a pending transaction is completed.

After the user A chooses the beacon payment function on the user interface 23 of the first mobile device 201, purchasing content, such as merchandise name, quantity, amount and the like, of the instant transaction is displayed on the user interface 23. The user A can then select options on the user interface 23 for confirming payment or cancelling the transaction in handling the instant transaction. After the option for payment confirmation is selected, the beacon APP of the first mobile device 201 adopts a beacon payment method through a payment service sing digital wallet. After the digital wallet is deducted for payment, the beacon APP of the first mobile device 201 informs the user A. The first beacon transceiving module 12 then transmits a signal or message for discharging merchandise to the control module 13 for the control module 13 to control the vending machine 10 to discharge the merchandise. After the merchandise is discharged, the control module 13 unlocks the operation interface 11 of the vending machine 10, allowing other user(s) to perform purchase operation on the vending machine 10.

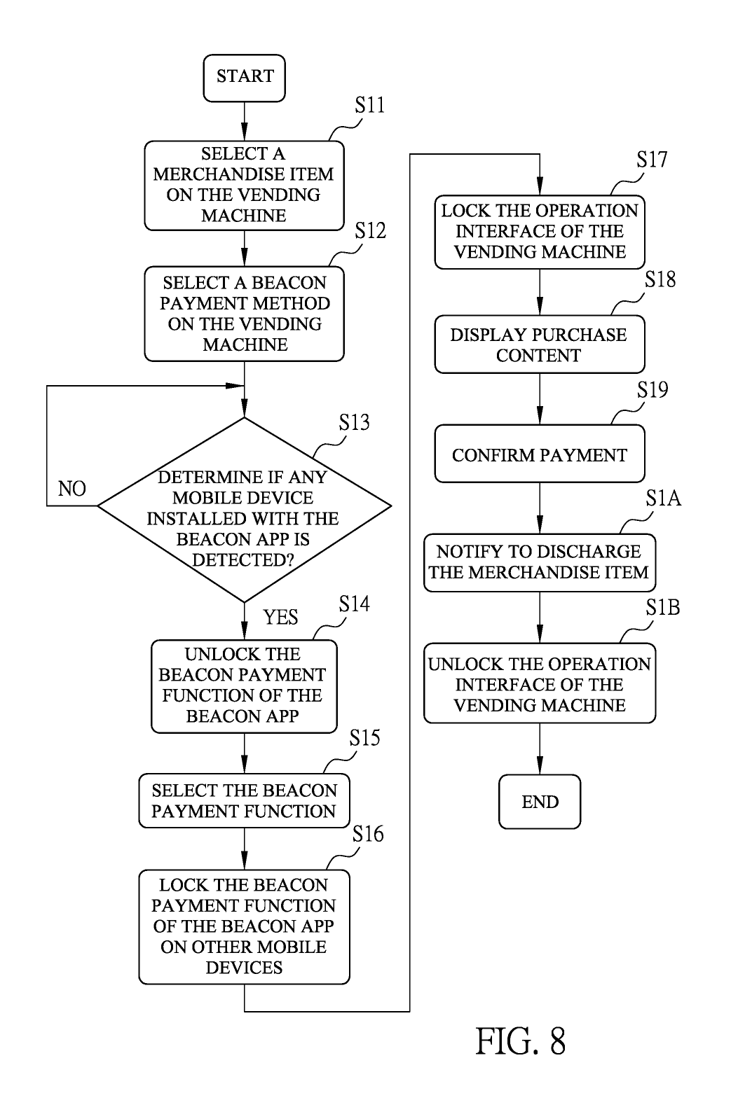

With reference to FIGS. 4 and 8, a first embodiment of a method for operating a beacon-based vending system in accordance with the present invention corresponds to the operation situation I and includes the following steps.

Step S11: Select a merchandise item to be purchased on the vending machine 10. The user A makes the selection of the merchandise item.

Step S12: Select a beacon payment method on the vending machine 10.

Step S13: Determine if any mobile device installed with the beacon APP is scanned and detected through the first beacon transceiving module 12 of the vending machine 10. If no mobile device is detected., resume step S13. For example, when the first mobile device 201 is not powered on by the user A, the first beacon transceiving module 12 fails to detect the first mobile device 201 installed with the beacon APP. Otherwise, perform step S14. In step S13, a scanning time can be configured and is not limited to 10 seconds.

Step S14: Unlock the beacon payment function of the beacon APP installed on the detected mobile device, for example, the first mobile device 201, through the first beacon transceiving module 12.

Step S15: Select the beacon payment function on the user interface 23 of the first mobile device 201.

Step S16: Lock the beacon payment function of the beacon APP installed on other mobile devices excluding the detected mobile phone, that is, the first mobile device 201, through the first beacon transceiving module 12 to avoid two (or more) payers paying a single transaction.

Step S17: Transmit a signal or message for locking the operation interface 11 of the vending machine 10 through the first beacon transceiving module 12 to the control module 13 for the control module 13 to lock the operation interface 11. Therefore, when the instant transaction is not completed yet, the chance of other users also performing purchase operation on the vending machine 10 can be avoided.

Step S18: Display purchase content on the operation interface 23 of the first mobile device 201 after selecting the beacon payment function of the beacon APP installed on the first mobile device 10.

Step S19: Confirm payment through the user interface 23 and select a beacon payment method through a payment service using digital wallet (eDollar) to complete payment. After the digital wallet is deducted for payment, inform the user A through the beacon APP of the first mobile device 201.

Step S1A: Transmit a signal or message for discharging the merchandise item from the first beacon transceiving module 12 to the control module 13 for the control module 13 to control the vending machine 10 to discharge the merchandise item.

Step S1B: Unlock the operation interface 11 of the vending machine 10 through the control module 13 after the merchandise item is discharged to allow other users to perform purchase operation on the vending machine 10. Sequences of steps S16, S17 and S18 are not limited to those as shown on FIG. 8 and may be interchanged or simultaneously performed.

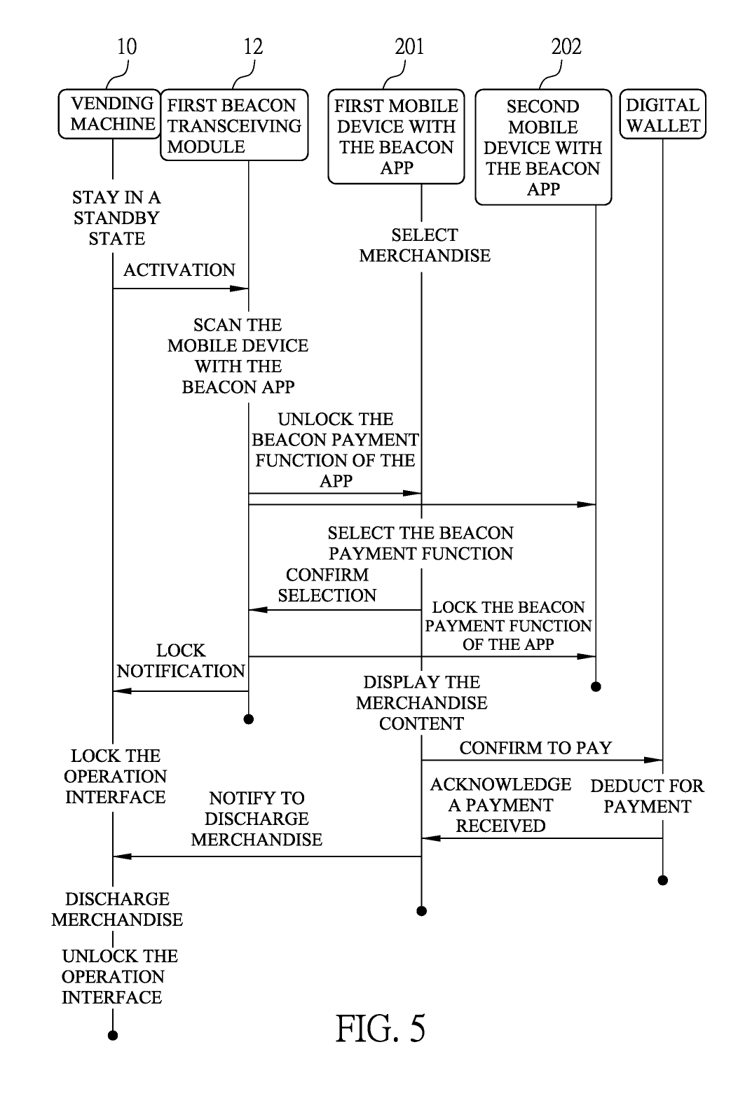

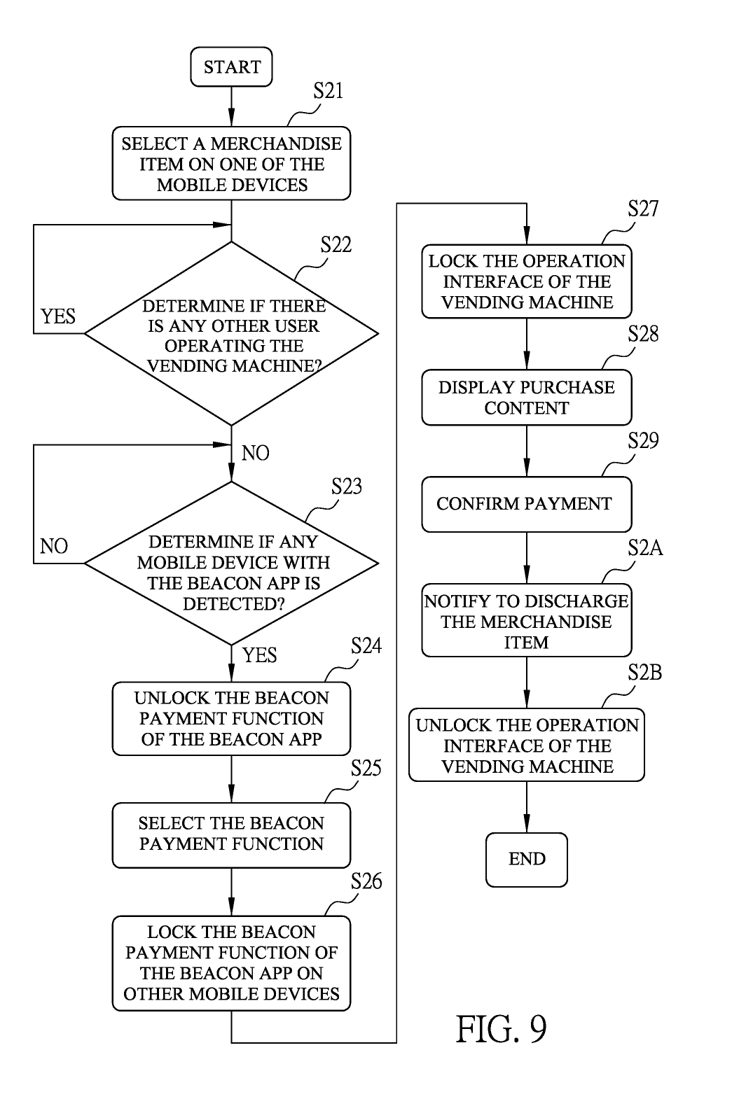

With reference to FIGS. 5 and 9, a second embodiment of a method for operating a beacon-based vending system in accordance with the present invention corresponds to the operation situation II and includes the following steps.

Step S21: Select a merchandise item to be purchased on one of the mobile devices 20. The user A makes the selection of the merchandise item.

Step S22: Determine if there is any other user (excluding the user A) operating the operation interface 11 of the vending machine 10 for merchandise purchasing through the control module 13 of the vending machine 10. When there is any other user purchasing merchandise on the vending machine 10, the transaction performed by the other user is of priority. A wait time including but not limited to 60 seconds can be set. When the control module 13 detects any other user operating the vending machine before expiration of the wait time, the transaction performed by the user A is terminated. Otherwise, when the control module 13 detects no other operating the vending machine 10 within the wait time, perform step S23.

Step S23: Determine if any mobile device with the beacon APP installed and. executed therein is detected through the first beacon transceiving module 12 of the vending machine 10.

As being similar to steps S13 to S1B in FIG. 8, steps S23 to S2B are not repeated here.

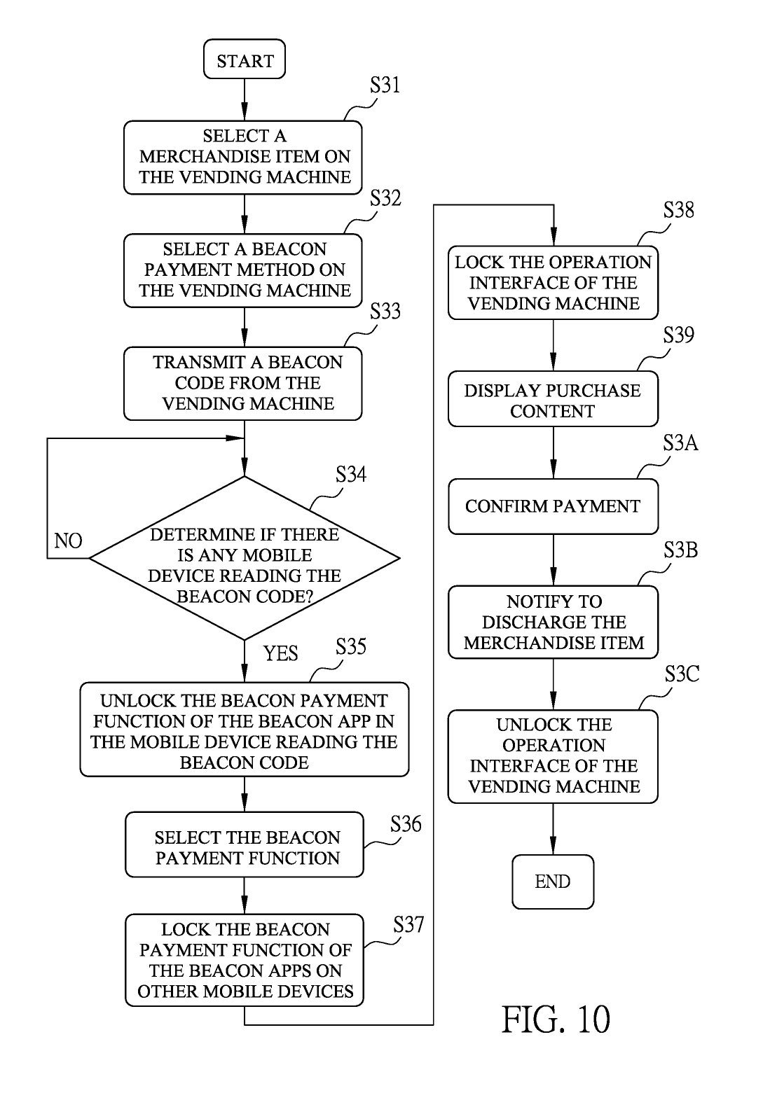

With reference to FIGS. 6 and 10, a third embodiment of a method for operating a beacon-based vending system in accordance with the present invention corresponds to the operation situation III and includes the following steps.

Step S31: Select a merchandise item to be purchased on the vending machine 10. The user A makes the selection of the merchandise item on the vending machine.

Step S32: Select a beacon payment method on the vending machine 10.

Step S33: Actively transmit beacon signals to provide a beacon code of the vending machine 10 through the first beacon transceiving module 12.

Step S34: Determine if there is any mobile device detected to read the beacon code through the first beacon transceiving module 12. When there is no mobile device detected to read the beacon code, resume step S34. For example, the first mobile device 201 is not powered on by the user A, the first beacon transceiving module 12 fails to detect the first mobile device 201 installed with the beacon APP. A read time including but not limited to 10 seconds can be set. When the first beacon transceiving module 12 detects any mobile device reading the beacon code before expiration of the read time, the instant transaction is terminated. Otherwise, when the first beacon transceiving module 12 detects any mobile device reading the beacon code before expiration of the read time (for example, the first mobile device 201 responds to the first beacon transceiving module 12 with a signal or message for read acknowledgement), perform step S35.

Step S35: Unlock the beacon payment function of the beacon APP in the mobile device reading the beacon code.

As being similar to steps S14 to S1B in FIG. 8, steps S35 to S3C are not repeated here.

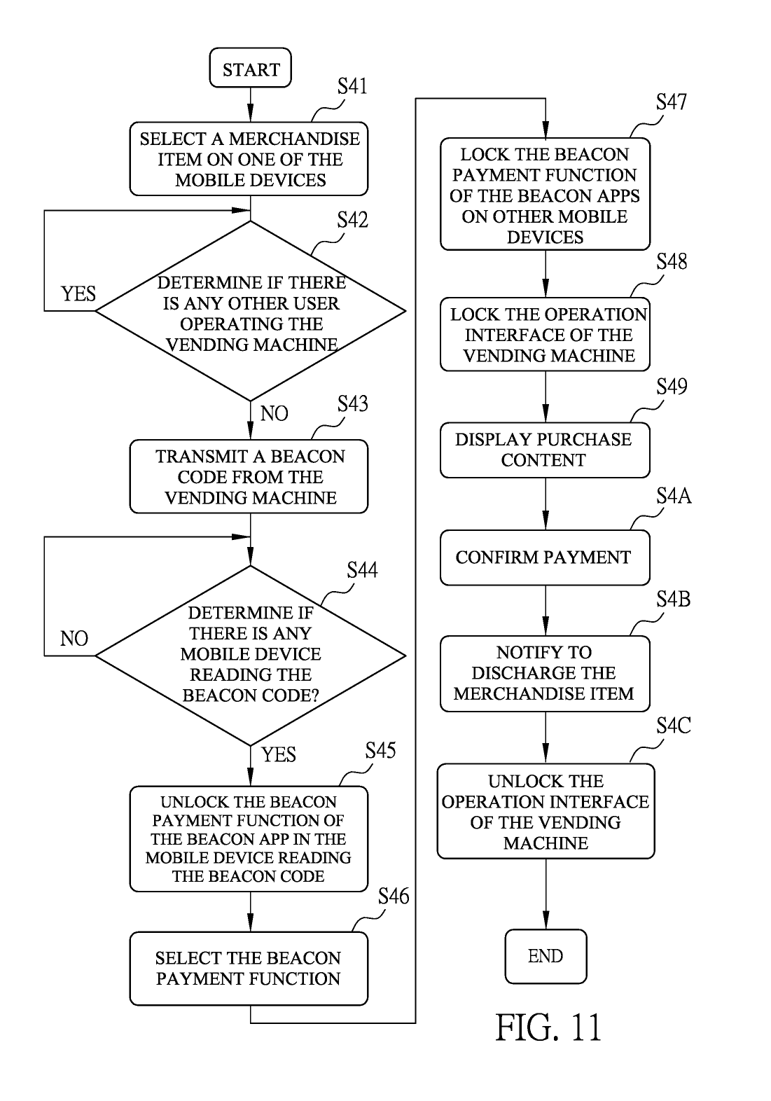

With reference to FIGS. 7 and 11, a fourth embodiment of a method for operating a beacon-based vending system in accordance with the present invention corresponds to the operation situation iv and includes the following steps.

Step S41: Select a merchandise item to be purchased on one of the mobile devices 20. The user A makes the selection of the merchandise item.

Step S42: Determine if there is any other user (excluding the user A) operating the operation interface 11 of the vending machine 10 for merchandise purchasing through the control module 13 of the vending machine 10. When there is other user purchasing merchandise on the vending machine 10, the transaction performed by the other user is of priority. A wait time including but not limited to 60 seconds can be set. When the control module 13 detects any other user operating the vending machine before expiration of the wait time, the transaction performed by the user A is terminated. Otherwise, when the control module 13 detects no other operating the vending machine 10 within the wait time, perform step S43.

As being similar to steps S33 to S3C in FIG. 10, steps S43 to S4C are not repeated here.

In sum, the present invention has the following features and advantages: when authenticating the mobile phone (identity of the payer) performing a transaction for purchasing merchandise, the first beacon transceiving module 12 determines the mobile devices not selecting the beacon payment function as the mobile devices not performing the transaction (not an identity of the payer) depending on whether the first beacon transceiving module detects other mobile devices or receives read acknowledgement from other mobile devices. Thus, no additional security authentication is required to authenticate user's identity, thereby attaining secure and precise transaction, simplifying consumers' transaction processes, shortening transaction time, enhancing users' operational convenience, and increasing consumer's purchasing intention

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the tennis in which the appended claims are expressed.

What is claimed is:

1. A method for operating a beacon-based vending system, wherein the vending system has a vending machine and multiple mobile devices, the vending machine has a first beacon transceiving module and a control module electrically connected, and each mobile device is installed with a beacon application, the method comprising steps of:
selecting a merchandise item according to a user's operation on the vending machine for the vending machine to generate a merchandise selection result;
performing a beacon payment selection according to the user's operation and the merchandise selection result to generate a beacon payment selection result through the vending machine;
determining if one of the mobile devices is a payer device according to the beacon payment selection result through the first beacon transceiving module of the vending machine;
when the mobile device is a payer device, unlocking a beacon payment function of the beacon application installed on the payer device through the first beacon transceiving module; and
performing the beacon payment function of the beacon application through the payer device.

2. The method as claimed in claim 1, wherein in the step of determining if the mobile device is the payer device, the mobile device is determined to be the payer device when the first beacon transceiving module scans and detects the mobile device with the beacon application installed and executed thereon.

3. The method as claimed in claim 1, wherein in the step of determining if the mobile device is the payer device, the mobile device is determined to be the payer device when the first beacon transceiving module transmits a beacon code and the beacon code is read by the mobile device.

4. The method as claimed in claim I, wherein in the step of determining if the mobile device is the payer device, the first beacon transceiving module of the vending machine simultaneously detects at least one of the mobile devices other than the payer device and determines the detected mobile device as a non-payer device, and after the step of performing the beacon payment function of the beacon application, the first beacon transceiving module locks the beacon payment function of the non-payer device.

5. The method as claimed in claim 2, wherein in the step of determining if the mobile device is the payer device, the first beacon transceiving module of the vending machine simultaneously detects at least one of the mobile devices other than the payer device and determines the detected mobile device as a non-payer device, and after the step of performing the beacon payment function of the beacon application, the first beacon transceiving module locks the beacon payment function of the non-payer device.

6. The method as claimed in claim 3, wherein in the step of determining if the mobile device is the payer device, the first beacon transceiving module of the vending machine simultaneously detects at least one of the mobile devices other than the payer device and determines the detected mobile device as a non-payer device, and after the step of performing the beacon payment function of the beacon application, the first beacon transceiving module locks the beacon payment function of the non-payer device.

7. The method as claimed in claim 4, wherein after the first beacon transceiving module locks the beacon payment function of the non-payer device, the method further comprises steps of:
locking the vending machine through the control module of the vending machine;
displaying a purchasing content through the beacon application of the payer device for a user of the payer device to select a merchandise item in generation of a transaction;
selecting a beacon payment method for the transaction through a payment service using digital wallet through the beacon application of the payer device;
transmitting a signal or message for discharging merchandise to the control module through the first beacon transceiving module after the digital wallet is deducted for payment allowing the control module to control the vending machine to discharge the merchandise item; and
unlocking the vending machine through the control module after the merchandise item is discharged.

8. The method as claimed in claim 5, wherein after the first beacon transceiving module locks the beacon payment function of the non-payer device, the method further comprises steps of:
locking the vending machine through the control module of the vending machine;
displaying a purchasing content through the beacon application of the payer device for a user of the payer device to select a merchandise item in generation of a transaction;
selecting a beacon payment method for the transaction through a payment service using digital wallet through the beacon application of the payer device;
transmitting a signal or message for discharging merchandise to the control module through the first beacon transceiving module after the digital wallet is deducted for payment allowing the control module to control the vending machine to discharge the merchandise item; and
unlocking the vending machine through the control module after the merchandise item is discharged.

9. The method as claimed, in claim 6, wherein after the first beacon transceiving module locks the beacon payment function of the non-payer device, the method further comprises steps of:
locking the vending machine through the control module of the vending machine;
displaying a purchasing content through the beacon application of the payer device for a user of the payer device to select a merchandise item in generation of a transaction;
selecting a beacon payment method for the transaction through a payment service using digital wallet through the beacon application of the payer device;
transmitting a signal or message for discharging merchandise to the control module through the first beacon transceiving module after the digital wallet is deducted for payment allowing the control module to control the vending machine to discharge the merchandise item; and
unlocking the vending machine through the control module after the merchandise item is discharged.

10. A method for operating a beacon-based vending system, wherein the vending system has a vending machine and multiple mobile devices, the vending machine has a first beacon transceiving module and a control module electrically connected, and. each mobile device is installed with a beacon application, the method comprising steps of:
selecting a merchandise item according to a user's operation on one of the mobile devices for the mobile device to generate a merchandise selection result;
determining if the mobile device is a payer device according to the merchandise selection result through the first beacon transceiving module of the vending machine;
when the mobile device is the payer device, unlocking a beacon payment function of the beacon application installed on the payer device through the first beacon transceiving module; and
performing the beacon payment function of the beacon application through the payer device.

11. The method as claimed in claim 10, wherein in the step of determining if the mobile device is a payer device, the mobile device is determined to be the payer device when the first beacon transceiving module scans and detects the mobile device with the beacon applications installed and executed thereon.

12. The method as claimed in claim 11, wherein in the step of determining if the mobile device is the payer device, the mobile device is determined to be the payer device when the first beacon transceiving module transmits a beacon code and the beacon code is read by the mobile device.

13. The method as claimed in claim 10, wherein in the step of determining if the mobile device is the payer device, the first beacon transceiving module of the vending machine simultaneously detects at least one of the mobile devices other than the payer device and determines the detected mobile device as a non-payer device, and after the step of performing the beacon payment function of the beacon application, the first beacon transceiving module locks the beacon payment function of the non-payer device.

14. The method as claimed in claim 11, wherein in the step of determining if the mobile device is the payer device, the first beacon transceiving module of the vending machine simultaneously detects at least one of the mobile devices other than the payer device and determines the detected mobile device as a non-payer device, and after the step of performing the beacon payment function of the beacon application, the first beacon transceiving module locks the beacon payment function of the non-payer device.

15. The method as claimed in claim 12, wherein in the step of determining the mobile device is the payer device, the first beacon transceiving module of the vending machine simultaneously detects at least one of the mobile devices other than the payer device and determines the detected mobile device as a non-payer device, and after the step of performing the beacon payment function of the beacon application, the first beacon transceiving module locks the beacon payment function of the non-payer device.

16. The method as claimed in claim 13, wherein after the first beacon transceiving module locks the beacon payment function of the non-payer device, the method further comprises steps of:
locking the vending machine through the control module of the vending machine;
displaying a purchasing content through the beacon application of the payer device for a user of the payer device to select a merchandise item in generation of a transaction;
selecting a beacon payment method for the transaction through a payment service using digital wallet through the beacon application of the payer device;
transmitting a signal or message for discharging merchandise to the control module through the first beacon transceiving module after the digital wallet is deducted for payment allowing the control module to control the vending machine to discharge the merchandise item; and
unlocking the vending machine through the control module after the merchandise item is discharged.

17. The method as claimed in claim 14, wherein after the first beacon transceiving module locks the beacon payment function of the non-payer device, the method further comprises steps of:
locking the vending machine through the control module of the vending machine;
displaying a purchasing content through the beacon application of the payer device for a user of the payer device to select a merchandise item in generation of a transaction;
selecting a beacon payment method for the transaction through a payment service using digital wallet through the beacon application of the payer device;
transmitting a signal or message for discharging merchandise to the control module through the first beacon transceiving module after the digital wallet is deducted for payment allowing the control module to control the vending machine to discharge the merchandise item; and
unlocking the vending machine through the control module after the merchandise item is discharged.

18. The method as claimed in claim 15, wherein after the first beacon transceiving module locks the beacon payment function of the non-payer device, the method further comprises steps of:
locking the vending machine through the control module of the vending machine;
displaying a purchasing content through the beacon application of the payer device for a user of the payer device to select a merchandise item in generation of a transaction;
selecting a beacon payment method for the transaction through a payment service using digital wallet through the beacon application of the payer device;
transmitting a signal or message for discharging merchandise to the control module through the first beacon transceiving module after the digital wallet is deducted for payment allowing the control module to control the vending machine to discharge the merchandise item; and
unlocking the vending machine through the control module after the merchandise item is discharged.

19. The method as claimed in claim 15, wherein before the step of determining if the mobile device is a payer device, the control module of the vending machine determines if the vending machine stays at a standby state.
